(19) United States
(12) Patent Application Publication
(10) Pub. No.: US 2003/0152309 A1
(43) Pub. Date: Aug. 14, 2003

(54) Printed circuit board containing optical elements

(76) Inventors: James Robert Howard, Carson City, NV (US); Gregory Lucas, Newark, CA (US)

Correspondence Address: James Howard, 4782 Lango Dr., Carson City, NV, 89706, US

(21) Appl. No.: 10/074,926

(22) Filed: Feb. 14, 2002

(51) Int. Cl. G02B 6/12

(52) U.S. Cl. 385/14

(57) ABSTRACT

A printed circuit board containing internal devices for optical generation, transmission and reception in the X and Y dimension of the plane and electrical connection of the plane. The printed circuit board may contain planes that are capacitively coupled upon which the optical devices may be formed for the reduction of electrical noise (EMI) and the removal of heat from the area of the optical devices. This printed circuit board is intended to internally transmit and receive data at faster rates than can be achieved by electrical transmission across the same distances.

### FIELD OF THE INVENTION

The present invention relates to a printed circuit board populated with active surface devices that are connected by optical means formed or mounted on a capacitive power bus located within the printed circuit board.

### BACKGROUND OF THE INVENTION

Printed circuit boards have previously been formed as laminated structures and have been populated with devices such as integrated circuits and the supporting elements, which may be used in a wide variety of electronic applications. More recently optical devices have been added to the printed circuit boards to transmit optical signals to locations remote from the printed circuit board and to communicate with other devices located on the same printed circuit board. Typically, these optical devices and interconnecting transmission medium, such as an optical fiber, have been located on the surface of the printed circuit board because of the necessity to make contact with the integrated circuit, or other device, and the physical difficulty in placing a optical transmission element, such as an optical fiber, within the printed circuit board.

Substantial effort has been expended to design an appropriate optical interconnection scheme between the electrical devices mounted on a printed circuit board, due to the faster speed of transmission of an optical signal in comparison to the speed of an electrical signal within a conductor, and the elimination of such electrical effects such as the generation of electromagnetic interference or EMI within the conductor as the current passes through.

Generally an optical transmission design includes the elements of a light generation device such as a laser diode which receives an electrical signal from and may be formed within or on an active device such as an integrated circuit. A light transmission element such as an optical fiber then carries the light to a distant receiving element such as a photodiode, which then converts the light signal into an electrical signal which may then be further processed.

One novel approach to this design was set forth by Muhammed Shahid of Lucent Technologies in U.S. Pat. No. 6,185,348 in which a method for assembling a multifiber optical connection circuit was disclosed which could be used to form simple coverings for the group of optical fibers contained within. The Shahid method does not contemplate a method of integrating this multifiber optical ribbon within a fabricated printed circuit board in which holes must be drilled, circuits must be routed and following substantial chemical and physical processing must be laminated or formed into a final fabricated unit.

Additionally other methods of encompassing optical fibers within flexible materials for bundling of circuit elements have provided a better external interconnect capability.

Other techniques have also been considered such as ultilizing a refractory lens or mirror to conduct light from a surface device to a channel or optical fiber within the PCB. These techniques were also not found to solve the problem that the present invention is intended to solve. The inherent instability of the position of such devices as a lens or mirror within the PCB or affixed between the PCB and a surface device would render such a solution impractical and unreliable. Additionally, the additional electromagnetic interference or EMI from the high-speed optical devices might provide a significant degradation to the operation of the assembled device.

### SUMMARY OF THE INVENTION

Accordingly, it is an object of the present invention to provide a an effective and workable solution to the problem of interconnecting devices on a PCB by means of optical channels within the printed circuit board.

The concept of the present invention is to connect the surface device in the Z direction or into the PCB with a standard electrical connection, such as a blind via, and place the laser diode or other optical generation device on the surface of a capacitive power/ground sandwich layer. The laser diode would then generate optical signals which would be transmitted through an optical fiber or other optically conductive material, the fiber or conductive material all lying on the same plane, to a photodiode or other receiving device which would convert the optical signal into electrical signal for transportation in copper conductive through holes or other conductors in the Z, X or Y directions within the PCB. By designing the PCB in this fashion the problem of bending light to be channeled inside the printed circuit board is solved as the electrical signal proceeds a very short distance into the PCB. The optical generation transmission and reception devices are all formed or mounted on the same plane, eliminating the problem encountered in the mechanical changes in size and shape that a PCB undergoes when it is exposed to heat or other stress.

It is the object of the present invention to place the capactitive power/ground plane a near to the surface components as is practicable to shorten the path of electrical flow. It is contemplated in the current invention that the plated through holes or PTHs from the surface devices may be formed as blind vias with short length, low via inductance and inherently lower EMI generation. In typical applications these blind vias may be 0.005 inches or shorter to enable an electrical connection to the power ground plane upon which the optical elements will be formed. In contrast the optical portion of the circuit (as an example) may be 12 inches in length, with a ratio of 10:12,000 electrical to optical length of connection, making the time of signal travel in the electrical signal portion irrelevant.

It is more specifically the object of the current invention to form channels in the conductive coating of the power ground layer for the placement of optical fibers or the formation of channels which may be filled with a optically transmissive material in a subsequent process. These optically conductive fibers or channels may additionally receive coating to prevent the unintentional transmission of light to other elements. This coating may take many forms including plating, polymers, or epoxy materials.

It is an additional object of the invention to provide a capacitive base sandwich for the operation of the electrical devices that form the optical elements to suppress EMI from those elements. Acting as a high speed capacitive buss element the power/ground layer will capacitivly couple some of the high speed electrical noise, reducing the electrical interference that may effect the devices on the PCB or be radiated as EMI.

Similarly it is a related object of the invention to provide methods of manufacture of the PCB as described above.

Additional objects and advantages of the invention are made apparent in the following description having made reference to the accompanying drawings.

### BRIEF DESCRIPTION OF THE DRAWINGS

FIG. 1 is a schematic side sectional view of the printed circuit board showing the elements of the present invention, including a capacitor laminate within the printed circuit board with optical transmission and reception formed on the layer. Surface devices and methods of connection to the surface are also illustrated.

FIG. 2 is a top view of the printed circuit board represented in FIG. 1. FIG. 2 illustrates the proliferation of optical pathways in the X and Y axis of the printed circuit board

FIG. 3 is a schematic side sectional view of the printed circuit board showing a different construction of the PCB with the optical element formed on a non capacitor layer and connected to the surface with additional subcomposit and blind via holes.

### DESCRIPTION OF THE PREFERRED EMBODIMENT

An optical printed circuit board with electrical connections in the Z axis and optical connections in the X and Y axis according to the present invention is described in greater detail below. For the purposes of this embodiment, the Z axis of the printed circuit board is the direction through the printed circuit board layers that the via holes pass through and is typically very thin, as an example thickness ranges from 0.002 inches to 0.5 inches are not uncommon. The X and Y dimensions are the dimensions of the surface of the printed circuit board or “PCB” which are typically the approximate size of the internal layers as well. Many different embodiments may be incorporating the same PCB features described. Types of devices used, layer count, line width, layer thickness, types of holes used or methods of manufacture are all examples of variations that may occur to the PCB without changing the basic application of the current invention.

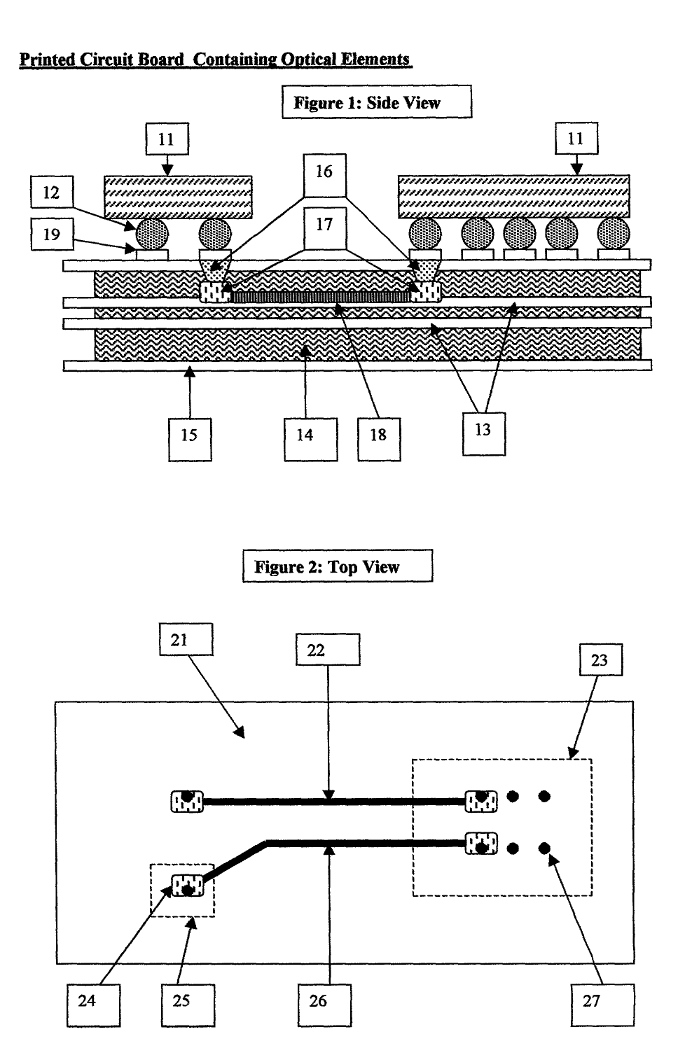

Referring to FIG. 1 the PCB shown has an internal capacitor layer, preferably a power ground 13 sandwich with a thin dielectric core. Formed upon this core are the devices used to generate and receive optical information, usually as high speed pulses. These devices 17, may be existing devices such as laser, LED or newer organo-metallic or other devices. They may include known devices as photodetectors for receiving elements or may be composed of other materials that will perform the same task. These devices will transmit and receive electrical signals from the surface devices 11, which are devices such as BGA, CGA or other such digital or analog processing devices. An advantage of the present invention is the reduction of electrical noise generated by the optical devices, as well as the general reduction of electrical noise generated by the digital portion of the PCB as noted in U.S. Pat. Nos. 5,079,069 and 5,155,655 both to Howard et al. Additionally, the preferred embodiment views the mounting of these devices on the conductive layer, most preferably copper as a good method of removing heat from the devices due to the large amount of a very good heat conductive material in the copper plane.

The optical transmission element 18 may be formed through processing through several different methods or may be a premade optical fiber which may be incorporated on the layer during the manufacturing of the PCB. Some of the manufacturing methods may include etching paths in the copper foil on the surface 13 of the capacitor layer, then filling the paths with an optically clear material and curing that material to provide stability. Optical fibers may be secured in the etched paths or on the surface of the copper or other conductive material to accomplish the same task. The etched paths may be formed as open channels with no filler material, or filled with gas or vacuum to promote optical clarity. It may be advantageous in the most preferred embodiment to only partially etch through the conductive surface to provide an optically reflective channel on three sides, which may be fully encapsulated with a reflective surface on the top surface to completely enclose the light transmissive channel. It is fully contemplated within the preferred embodiment that a highly internal surface is preferable within the light transmissive channels,which are formed in or on the conductive surface. All these methods are contemplated within the current invention.

14 and 15 show additional common circuit elements of copper and dielectric material, which further compose the PCB. This construction method may include the method of using resin coated copper or “RCC” to facilitate the use of laser or other processing to form the via holes 16 in the most preferred method. Additionally, 12 shows a common connection method of assembly using solder balls to connect device 11 to pad 19.

16 shows a blind via which connects the surface pad 19 electrically to the optical transmission and reception elements 17. Utilizing the shortest and most inductance free method of connection between the surface device and the optical elements is considered to be the most preferred embodiment of the current invention. It is one preferred embodiment of the current invention to use conductive polymer as a method of forming the conductive via hole. This method will allow greater process flexibility in the types of interconnection methods that may be employed in the final method.

Referring now to FIG. 2, this figure shows a top view of the PCB in FIG. 1 as 21 with surface device 11 shown as top view 23 or 24, solder ball 12 shown as top view 27, optical generation or reception device 17 shown as 24 and optical transmission element 18 shown as 22 or 26. As is shown 24 or 26 may move freely in the X and Y axis of the PCB but does not travel in the Z axis. The key reasons are the impractical nature of 90 degree or greater bending of light within a very unstable polymer structure such as a PCB, and the very short distances that electrical signals must travel in the Z axis in the preferred embodiment in comparison to the travel of light transmission channels in the X and Y dimensions.

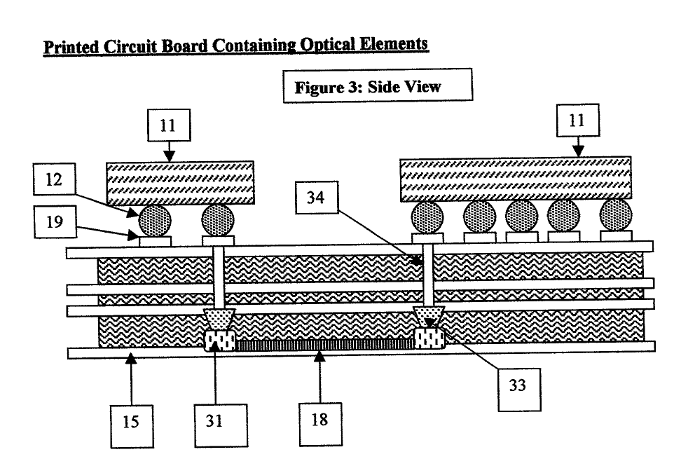

FIG. 3 shows a schematic side view of the PCB similar to FIG. 1 but demonstrating that the optical elements 31,18 may be formed on a different layer 15. This demonstrates the possibility of placing the elements on any layer within the current invention. Connection hole 34 is added to provide the necessary electrical connections to the surface devices.

The foregoing preferred embodiments are intended to illustrate rather than limit the scope of the invention. Those skilled in the art will recognize that the illustrated embodiments could be modified without departing from the scope of the following claims.

What is claimed is:

1. A printed circuit board (PCB), comprising
multiple layers laminated about optical generation, transmission and reception elements formed on a capacitor laminate,
the capacitor laminate including:
two sheets of conductive material and one sheet of intermediate dielectric material,
the optical elements including:
a generation device,
a transmission element to provide an optically clear path between generation and reception elements,
and a reception device,
all optical elements being located on the same plane and connected electrically in the Z axis to all other printed circuit board elements and surface devices.

2. The PCB of claim 1 wherein the optical transmission paths are formed by selectively removing areas of the conductive material of the capacitor laminate and placing an optically conductive fiber connecting the optical generation device and the optical reception device.

3. The PCB of claim 1 wherein the optical transmission paths are formed by selectively removing areas of the conductive material from the surface of the capacitor laminate and placing an optically conductive polymer path connecting the optical generation device and the optical reception device.

4. The PCB of claim 1 wherein the optical transmission paths are formed by selectively removing areas of the conductive material from the surface of the capacitor laminate and a clear or open channel is formed within the PCB.

5. The PCB of claim 2 wherein the the optical generation device and the optical reception device are connected though the Z axis to other PCB elements by the use of blind, buried or subcomposite plated vias.

6. The PCB of claim 3 wherein the optical generation device and the optical reception device are connected though the Z axis to other PCB elements by the use of blind, buried or subcomposite plated vias.

7. The PCB of claim 4 wherein the optical generation device and the optical reception device are connected though the Z axis to other PCB elements by the use of blind, buried or subcomposite plated vias.

8. The PCB of claim 2 wherein the optical generation device and the optical reception device are connected though the Z axis to other PCB elements by the use of blind, buried or subcomposite conductive polymer vias.

9. The PCB of claim 3 wherein the optical generation device and the optical reception device are connected though the Z axis to other PCB elements by the use of blind, buried or subcomposite conductive polymer vias.

10. The PCB of claim 4 wherein the optical generation device and the optical reception device are connected though the Z axis to other PCB elements by the use of blind, buried or subcomposite conductive polymer vias.

11. The PCB of claim 5 in which multiple layers of optical elements formed on capacitor layers are laminated within the PCB.

12. The PCB of claim 6 in which multiple layers of optical elements formed on capacitor layers are laminated within the PCB.

13. The PCB of claim 7 in which multiple layers of optical elements formed on capacitor layers are laminated within the PCB.

14. The PCB of claim 8 in which multiple layers of optical elements formed on capacitor layers are laminated within the PCB.

15. The PCB of claim 9 in which multiple layers of optical elements formed on capacitor layers are laminated within the PCB.

16. The PCB of claim 10 in which multiple layers of optical elements formed on capacitor layers are laminated within the PCB.

17. A method for forming a PCB containing a capacitor layer with attached optical devices for the generation, transmission and reception of optical signals comprising the steps of:
coating the conductive layers of the capacitor layer with photolithigrapic material to define areas of both electrical conduction and optical paths remove the conductive material in the desired areas,
place optically conductive fibers in the optical paths formed in the conductive layers,
securing the fibers in place connect the fibers to the optical generation and reception elements,
form electrical paths to the optical generation and reception elements by the means of blind, buried or subcomposite plated via holes and,
laminate the PCB layers together.

18. The method of claim 17 wherein the conductive material is removed by chemical etching.

19. The method of claim 17 wherein the optical path is formed in the conductive layer by laser ablation.

20. The method of claim 17 wherein the optical paths are filled with an optically conductive polymer not an optically conductive fiber.

21. The method of claim 18 wherein the PCB layers are laminated together prior to the forming of the electrical paths for the connection of the optical generation and reception elements by the means of blind, buried or subcomposite plated via holes.

22. The method of claim 19 wherein the PCB layers are laminated together prior to the forming of the electrical paths for the connection of the optical generation and reception elements by the means of blind, buried or subcomposite plated via holes.

23. The method of claim 20 wherein the PCB layers are laminated together prior to the forming of the electrical paths for the connection of the optical generation and reception elements by the means of blind, buried or subcomposite plated via holes.

24. A printed circuit board (PCB), comprising
multiple layers laminated about optical generation, transmission and reception elements the optical elements including:
a generation device,
a transmission element to provide an optically clear path between generation and reception elements,
and a reception device, all optical elements being located on the same plane and connected electrically in the Z axis to all other printed circuit board elements and surface devices.

25. The PCB of claim 24 wherein the optical generation device and the optical reception device are connected though the Z axis to other PCB elements by the use of blind, buried or subcomposite plated vias.

26. The PCB of claim 24 wherein the optical generation device and the optical reception device are connected though the Z axis to other PCB elements by the use of blind, buried or subcomposite conductive polymer vias.

27. A method for forming a PCB containing a capacitor layer with attached optical devices for the generation, transmission and reception of optical signals comprising the steps of:
place optically conductive fibers in the optical paths formed in the conductive layers,
securing the fibers in place connect the fibers to the optical generation and reception elements,
laminate the PCB layers together,
form blind, buried or subcomposite vias to expose the end of the optical fiber,
form or attach the optical generation and/or reception elements at the ends of the optical fiber,
form final electrical paths to the optical generation and reception elements by the means of blind, buried or subcomposite plated via holes.
